(19) United States
(12) Patent Application Publication
(10) Pub. No.: US 2015/0193071 A1
(43) Pub. Date: Jul. 9, 2015

(54) DEVICE AND METHOD FOR RECOGNIZING GESTURE USING MULTI-TOUCH INFORMATION

(71) Applicant: SAMSUNG ELECTRO-MECHANICS CO., LTD., Suwon (KR)

(72) Inventors: Yoon-Seok OH, Suwon (KR); Ji-Hoon KIM, Suwon (KR); Sang-Hyun SIM, Suwon (KR)

(73) Assignee: SAMSUNG ELECTRO-MECHANICS CO., LTD., Suwon (KR)

(21) Appl. No.: 14/251,978

(22) Filed: Apr. 14, 2014

(30) Foreign Application Priority Data
Jan. 9, 2014 (KR) 10-2014-0003037

(51) Int. Cl. G06F 3/041; G06F 3/0488; G06F 3/044

(52) U.S. Cl. CPC G06F 3/0416; G06F 3/044; G06F 3/04883; G06F 2203/04104

(57) ABSTRACT

The present invention discloses a device and a method for recognizing a gesture by use of multi-touch information. The method for recognizing a gesture by use of multi-touch information in accordance with an embodiment of the present invention includes: obtaining one or more first critical nodes, each having a greater node value than a first critical value, from points touched; configuring a task box including all of the one or more first critical nodes; obtaining one or more second critical nodes, each having a greater node value than a second critical value, from the one or more first critical nodes included in the task box; obtaining a peak node having a highest node value compared to surrounding nodes from the second critical nodes; and counting the number of the peak nodes.

### CROSS-REFERENCE TO RELATED APPLICATIONS

This application claims the benefit of Korean Patent Application No. 10-2014-0003037, filed with the Korean Intellectual Property Office on Jan. 9, 2014, the disclosure of which is incorporated herein by reference in its entirety.

### BACKGROUND

1. Technical Field

The present invention relates to a device and a method for recognizing a gesture by use of multi-touch information.

2. Background Art

With the rapid increase in the use of electronic devices utilizing touch sensors, there has been a growing development of controlling the touch screen by use of fingers. While there are methods of controlling the touch screen by creating gestures using one finger or multiple fingers, multi-touch algorithms are used to recognize the gesture. For example, the multiple fingers are identified, and touches made by the same finger are recognized, in order to create a gesture using multiple fingers.

In the conventional multi-touch algorithm, the multi-touch gesture was possible after running complicated data-processing algorithms, such as labeling (an algorithm for grouping the touches), multi-touch detection (an algorithm for separating adjacent touches, such as watershed), and tracking (an algorithm for finding same touches from previous and current frames and assigning ID for each touch). While the electronic devices are getting smaller, and thus the battery has become smaller, the screen has become bigger and the amount of data to be processed has become increased, making a low-power operation much more important than before.

The related art of the present invention is disclosed in Korean Patent Publication No. 10-2013-0087868.

### SUMMARY

The present invention provides a device and a method for recognizing a gesture by use of multi-touch information that can be processed faster than the conventional methods and can be operated in conditions of poor SNR.

The present invention also provides a device and a method for recognizing a gesture by use of multi-touch information that can generate delicate zoom-in, zoom-out and rotation gestures.

The method for recognizing a gesture by use of multi-touch information in accordance with an embodiment of the present invention includes: obtaining one or more first critical nodes, each having a greater node value than a first critical value, from points touched; configuring a task box including all of the one or more first critical nodes; obtaining one or more second critical nodes, each having a greater node value than a second critical value, from the one or more first critical nodes included in the task box; obtaining a peak node having a highest node value compared to surrounding nodes from the second critical nodes; and counting the number of the peak nodes.

The node value can be a capacitance change value, and the task box can be a rectangle.

The step of configuring the task box can include: configuring horizontal lines passing the one or more first critical nodes; configuring vertical lines passing the one or more first critical nodes; obtaining a rectangle having a largest area from rectangles formed by the vertical lines and horizontal lines; and configuring the rectangle having the largest area as the task box.

The method can further include: computing a center of gravity of the task box; and generating a gesture corresponding to at least one selected from the group consisting of a movement direction and a movement distance of the center of gravity.

The method can further include, after counting the number of the peak nodes: detecting a change in the number of the peak nodes; and generating a gesture corresponding to the change in the number of the peak nodes.

The method can further include, after counting the number of the peak nodes; detecting a change in a distance between the peak nodes; and generating a gesture corresponding to the change in the distance between the peak nodes.

The method can further include: measuring a horizontal length and a vertical length of the task box; detecting changes in the horizontal length and the vertical length; and generating a gesture corresponding to the changes.

Another embodiment of the present invention provides a device for recognizing a gesture by use of multi-touch information that includes: at least one processor; a multi-touch information sensing screen; and a memory comprising program instructions. The program instructions are executable by the at least one processor to perform the steps of: obtaining one or more first critical nodes, each having a greater node value than a first critical value, from points touched; configuring a task box including all of the one or more first critical nodes; obtaining one or more second critical nodes, each having a greater node value than a second critical value, from the one or more first critical nodes included in the task box; obtaining a peak node having a highest node value compared to surrounding nodes from the second critical nodes; and counting the number of the peak nodes.

The node value can be a capacitance change value, and the task box can be a rectangle.

The step of configuring the task box can include: configuring horizontal lines passing the one or more first critical nodes; configuring vertical lines passing the one or more first critical nodes; obtaining a rectangle having a largest area from rectangles formed by the vertical lines and horizontal lines; and configuring the rectangle having the largest area as the task box.

The program instructions can be configured to further execute: computing a center of gravity of the task box; and generating a gesture corresponding to a movement direction of the center of gravity.

The program instructions can be configured to further execute, after counting the number of the peak nodes: detecting a change in the number of the peak nodes; and generating a gesture corresponding to the change in the number of the peak nodes.

The program instructions can be configured to further execute: measuring a horizontal length and a vertical length of the task box; detecting changes in the horizontal length and the vertical length; and generating a gesture corresponding to the changes.

Yet another embodiment of the present invention can provide any terminal including the device for recognizing a gesture by use of multi-touch information that can be selected from the group consisting of a portable terminal, a mobile terminal, a telematics terminal, a notebook computer, a digital multimedia broadcasting terminal, a personal digital assistant, a Wibro terminal, an Internet protocol television terminal, an audio video navigation terminal, a portable multimedia player and a GPS navigation terminal.

### BRIEF DESCRIPTION OF THE DRAWINGS

FIG. 1 is a flow diagram showing a method for recognizing a gesture by use of multi-touch information in accordance with an embodiment of the present invention.

FIG. 2 illustrates how a task box is configured in the method for recognizing a gesture by use of multi-touch information in accordance with an embodiment of the present invention.

FIG. 3 illustrates how second critical nodes are selected in the method for recognizing a gesture by use of multi-touch information in accordance with an embodiment of the present invention.

FIG. 4 illustrates how a gesture is recognized based on the number of peak nodes and the length between the peak nodes in the method for recognizing a gesture by use of multi-touch information in accordance with an embodiment of the present invention.

FIG. 5 illustrates how the center of gravity of the task box is used in the method for recognizing a gesture by use of multi-touch information in accordance with an embodiment of the present invention.

FIG. 6 illustrates how changes in horizontal length and vertical length are used in the method for recognizing a gesture by use of multi-touch information in accordance with an embodiment of the present invention.

FIG. 7 shows a device for recognizing a gesture by use of multi-touch information in accordance with an embodiment of the present invention.

### DETAILED DESCRIPTION

Hereinafter, certain embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain relevant conventional technology is determined to evade the point of the present invention, the pertinent detailed description will be omitted.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Hereinafter, certain embodiments of the present invention will be described in detail with reference to the accompanying drawings.

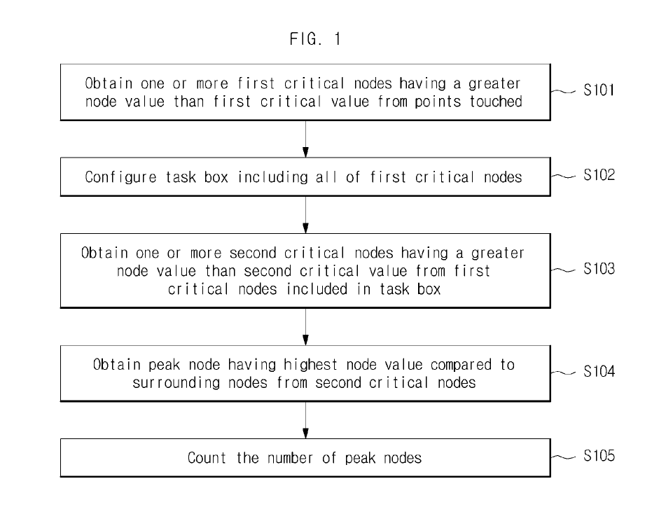

FIG. 1 is a flow diagram showing a method for recognizing a gesture by use of multi-touch information in accordance with an embodiment of the present invention.

Referring to FIG. 1, in step S101, one or more first critical nodes, each having a node value that is greater than a first critical value, can be obtained from points touched on a multi-touch information sensing screen MTS. Here, the node value can include a capacitance change value.

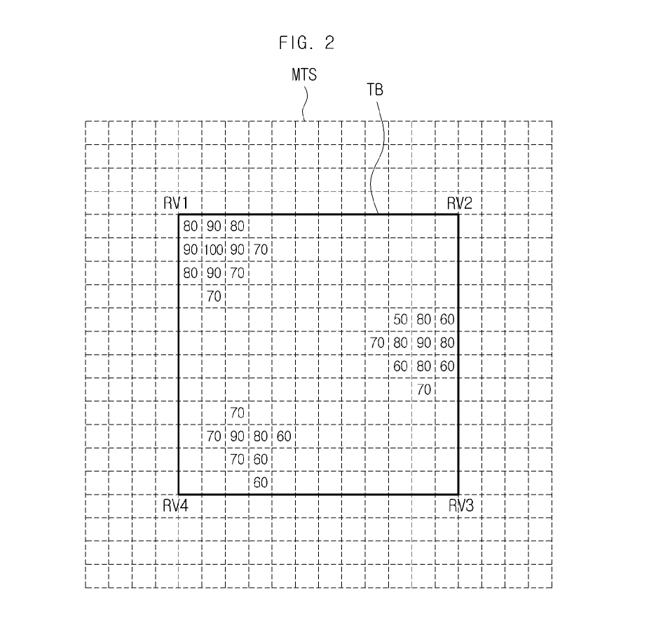

Here, referring to FIG. 2, the multi-touch information sensing screen MTS is shown in a checkered pattern, and capacitance changes of the touched points are shown in numerical values. Here, the numerical values are shown for the convenience of understanding only and do not have any units associated thereto. Furthermore, the scope of the present invention shall not be defined by the numerical values described herein.

If 60 is set for the first critical value, the nodes of the touched points on the multi-touch information sensing screen MTS having the node value of 60 or greater can be obtained among 400 nodes shown in FIG. 2. Specifically, 11 nodes can be obtained from an upper left portion, 8 nodes from a lower left portion, and 11 nodes from a middle right portion.

In step S102, a task box TB that includes all of the one or more first critical nodes can be configured. Here, the task box TB can include all of the first critical nodes.

To configure the task box TB, a plurality of rectangles consisting of vertical and horizontal lines can be obtained by drawing horizontal lines passing the one or more first critical nodes and drawing vertical lines passing the one or more first critical nodes.

By obtaining a rectangle having a largest area from the plurality of rectangles, the task box TB including all of the first critical nodes can be obtained. In an embodiment of the present invention, the task box TB can be a square or a rectangle. In FIG. 2, the task box TB is a square having vertices of RV1, RV2, RV3 and RV4.

In step S103, one or more second critical nodes, each having a node value that is greater than a second critical value, can be obtained from the one or more first critical nodes included in the task box TB.

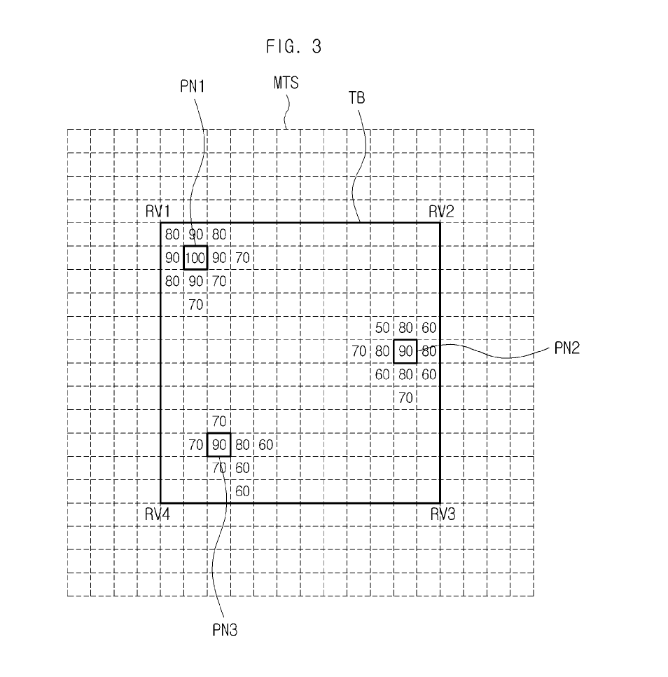

Referring to FIG. 3, if the second critical value is set as 80, 8 second critical nodes can be obtained from the upper left portion (i.e., 1 node having the node value of 100, 4 nodes having the node value of 90, and 3 nodes having the node value of 80), 2 second critical nodes from the lower left portion (i.e., 1 node having the node value of 90 and 1 node having the node value of 80), and 5 second critical nodes from the middle right portion (i.e., 1 node having the node value of 90 and 4 nodes having the node value of 80).

In step S104, a peak node having a highest node value compared to surrounding nodes can be obtained from the second critical nodes. In the upper left portion of FIG. 3, among the 8 second critical nodes (1 node having the node value of 100, 4 nodes having the node value of 90, and 3 nodes having the node value of 80), a peak node PN1 having the highest node value (i.e., 1 node having the node value of 100) compared to the surrounding nodes (i.e., 4 nodes having the node value of 90 and 3 nodes having the node value of 80) can be obtained.

Moreover, in the lower left portion, among the 2 second critical nodes (1 node having the node value of 90 and 1 node having the node value of 80), a peak node PN2 having the highest node value (i.e., 1 node having the node value of 90) compared to the surrounding nodes (i.e., 1 node having the node value of 80) can be obtained.

Moreover, in the middle right portion, among the 5 second critical nodes (1 node having the node value of 90 and 4 nodes having the node value of 80), a peak node PN3 having the highest node value (i.e., 1 node having the node value of 90) compared to the surrounding nodes (i.e., 4 nodes having the node value of 80) can be obtained.

In step S105, the number of peak nodes PN1, PN2, PN3 can be counted. In FIG. 3, it can be inferred that there are 3 peak nodes PN1, PN2, PN3.

Moreover, in the method for recognizing a gesture by use of multi-touch information in accordance with an embodiment of the present invention, a gesture corresponding to the number of peak nodes PN1, PN2, PN3 that is counted in step S105 can be generated.

In an embodiment, after counting the number of peak nodes PN1, PN2, PN3, it is possible to detect that the number of peak nodes PN1, PN2, PN3 is changed and then to generate a gesture corresponding to the variation in the number of peak nodes PN1, PN2, PN3. Here, the number of peak nodes PN1, PN2, PN3 can be increased or decreased.

In another embodiment, after counting the number of peak nodes PN1, PN2, PN3, it is possible to detect that the distances between the peak nodes PN1, PN2, PN3 are changed and then to generate a gesture corresponding to the variation in the distances between the peak nodes PN1, PN2, PN3. Here, the peak nodes PN1, PN2, PN3 can be increased or decreased.

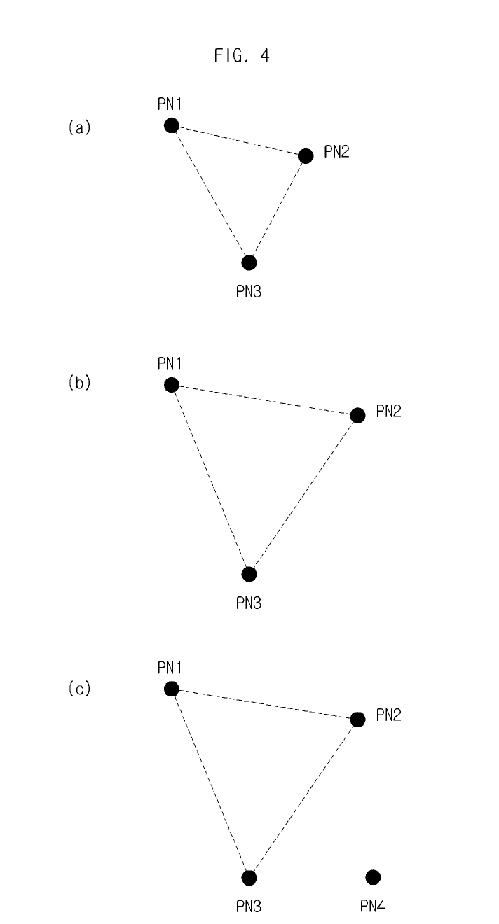

After counting that there are 3 peak nodes PN1, PN2, PN3, as shown in (a) of FIG. 4, it is possible to detect that the distances between the 3 peak nodes PN1, PN2, PN3 have been changed, as shown in (b) of FIG. 4. Here, a gesture corresponding to the variation of the distances between the peak nodes PN1, PN2, PN3 can be generated. As shown in (c) of FIG. 4, a new peak node PN4 can be detected. Here, a gesture corresponding to the variation of the number of peak nodes PN1, PN2, PN3, PN4 can be generated.

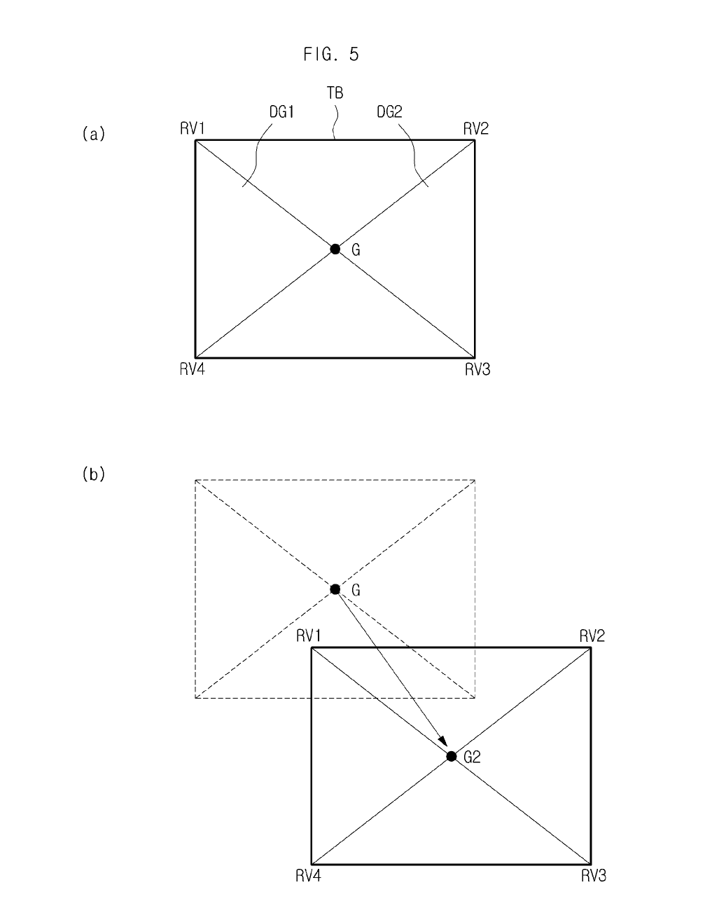

FIG. 5 illustrates how a center of gravity of the task box TB is used in the method for recognizing a gesture by use of multi-touch information in accordance with an embodiment of the present invention.

Referring to FIG. 5, a center of gravity G of the task box TB can be computed, and a gesture can be generated according to a movement direction and a movement distance of the center of gravity G. As shown in (a) of FIG. 5, the center of gravity G of the task box TB can be defined as an intersecting point where diagonal lines DG1, DG2 of the task box TB cross each other. As shown in (b) of FIG. 5, the task box TB is moved if the peak nodes PN1, PN2, PN3, PN4 are moved, and the movement of the task box TB moves the center of gravity G of the task box TB. Accordingly, it is possible to generate a gesture corresponding to the movement direction of the center of gravity G to a new center of gravity G2, and it is also possible to generate a gesture corresponding to the movement distance of the center of gravity G to the new center of gravity G2.

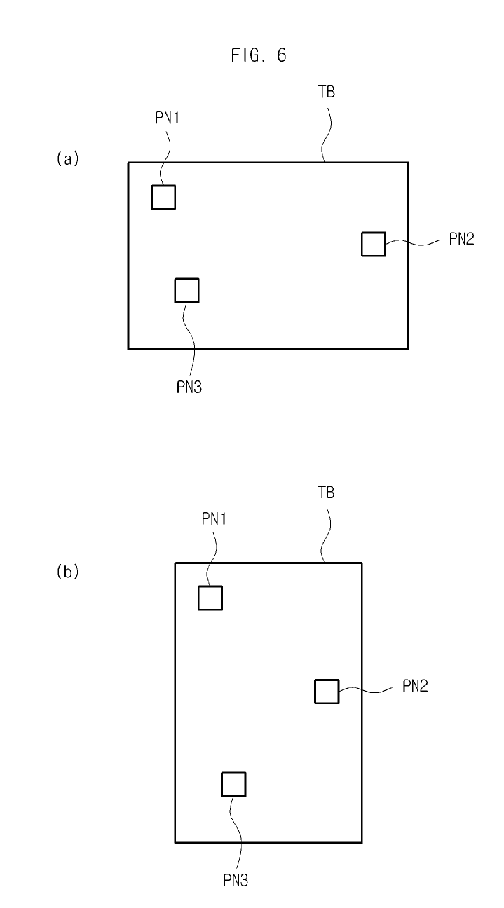

FIG. 6 illustrates how changes in horizontal length and vertical length are used in the method for recognizing a gesture by use of multi-touch information in accordance with an embodiment of the present invention.

The task box TB including the peak nodes PN1, PN2, PN3 is shown in (a) of FIG. 6. A new task box TB is formed by movement of the peak nodes PN1, PN2, PN3, in (b) of FIG. 6.

A vertical length and a horizontal length of the task box TB can be measured before the peak nodes PN1, PN2, PN3 are moved, and the variation in the vertical length and the horizontal length of the task box TB can be detected to generate a gesture corresponding to the variation.

An embodiment of the present invention can provide a recording medium having a computer-readable program for executing the method for recognizing a gesture by use of multi-touch information written therein. The steps of the method or algorithm described in combination with the embodiments disclosed herein can be directly realized in hardware, in a software module executed by a process, or a in the combination of the two.

The software module can reside in a RAM, a flash memory, a ROM, an EPROM, EEPROM, registers, a hard disk, a detachable disk, a CD-ROM or any other form of storage medium known in the art to which the present invention pertains. An exemplary storage medium should be able to couple with the processor, thereby allowing the processor to read and write data from and in the storage medium.

Alternatively, the storage medium can be combined with the processor. The processor and the storage medium can reside in an application specific integrated circuit (ASIC). The ASIC can be placed in a user terminal. Alternatively, the processor and the storage medium can reside as individual components in the user terminal.

All of the processes described above can be realized in software code modules executed in one or more universal or special-purpose computers or processors, and can be completely automated through the software code modules. The code modules can be stored in any form of computer-readable medium or other computer storage device or a combination of storage devices. Some or all of the methods can be alternatively realized in specialized computer hardware.

The methods and tasks described herein can be executed and fully automated by a computer system. The computer system can include a plurality of individual computers or computing devices (e.g., physical servers, workstations, storage arrays, etc.) that communicate and interact through a network in order to execute the described functions.

Each of the computing devices can include a processor (or multiple processors or circuits or a combination of circuits, for example, a module) that executes program instructions or modules that are stored in a memory or a non-transitory computer-readable storage medium.

Some or all of the various functions described herein can be realized by application-specific circuits (e.g., ASICs and or FPGAs) of a computer system, but the various functions described herein can be realized by the program instructions. When the computer system includes multiple computing devices, these devices are not necessarily arranged in a same location but can be arranged together. Results of the described methods and tasks can be permanently stored in different states by transformative physical storage devices, such as solid-state memory chips and/or magnetic disks.

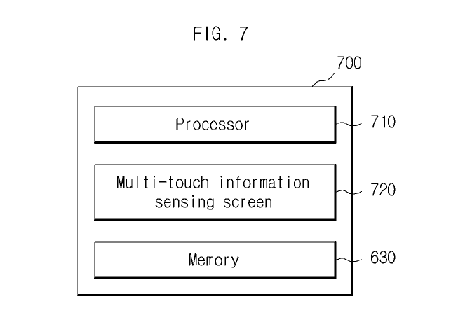

FIG. 7 shows a device for recognizing a gesture by use of multi-touch information in accordance with an embodiment of the present invention.

Referring to FIG. 7, a device 700 for recognizing a gesture by use of multi-touch information in accordance with an embodiment of the present invention can include a processor 710, a multi-touch information sensing screen 720 and a memory 730.

The multi-touch information sensing screen 720 can have touch information inputted therein. Here, the multi-touch information sensing screen 720 can be any means that can recognize a touch through a change in capacitance or a change in pressure. The memory 730 can have program instructions for recognizing a gesture by use of multi-touch information stored therein, and the processor 710 can execute the program instructions for recognizing a gesture by use of multi-touch information.

Here, the program instructions can execute the steps of obtaining one or more first critical nodes having a greater node value than a first critical value from points touched, configuring a task box including all of the one or more first critical nodes, obtaining one or more second critical nodes having a greater node value than a second critical value from the one or more first critical nodes included in the task box, obtaining a peak node having a highest node value compared to surrounding nodes from the second critical nodes, and counting the number of the peak nodes.

Embodiments of an application including the method for recognizing a gesture by use of multi-touch information described herein can be executed in one or more computer systems that can be interacted with various other devices.

In an embodiment, the computer system can include, but is not limited to, a portable device, a personal computer system, a desktop computer, a laptop, notebook or netbook computer, a main frame computer system, a handheld computer, a workstation, a network computer, a camera, a set-top box, a mobile device, a consumer device, a video game console, a handheld video game device, an application server, a storage device, a peripheral device such as a switch, a modem or a router, or any type of general computing or electronic device.

The computer system can include one or more processors that are coupled to a system memory through an input/output (I/O) interface. The computer system can further include a wired and/or wireless network interface coupled to the I/O interface, and can include one or more input/output devices, such as a cursor control device, a keyboard, display(s) and a multi-touch interface such as multitouch-enabled device.

While one embodiment can be realized to use a single instance of a computer system, another embodiment can be configured to allow a plurality of such system or a plurality of nodes constituting the computer system to host different portions or instances of the embodiments. For example, some elements can be realized through one or more nodes of another computer system that are different from the nodes realizing other elements.

In various embodiments, the computer system can be a uniprocessor system, which includes a single processor, or a multiprocessor system, which includes multiple processors (e.g., 2, 4, 8 or any other appropriate number of processors). The processors can be any appropriate processor that can executes instructions. For example, in various embodiments, the processors can be universal or embedded processors that realize any of various instruction set architectures (ISAs), such as the x86, PowerPC, SPARC or MIPS ISAs or any other suitable ISA. In the multiprocessor systems, each of the processors can generally, but not necessarily, realize the same ISA.

In an embodiment, at least one processor can be a graphic processing unit (GPU). The GPU can be regarded as a dedicated graphics-rendering device for a personal computer, workstation, game console or other computing or electronic device. The modern GPUs can be very efficient in manipulating and displaying computer graphics, and their highly parallel structure can make them more effective than general CPUs for a range complex graphic algorithms. For instance, the graphic processor can realize a plurality of graphic primitive operations in a way of executing the graphic primitive operations than directly drawing to the screen by use of a host central processing unit (CPU).

In various embodiments, the methods and techniques disclosed herein can be realized at least in pan by program instructions configured to be executed on one of, or executed parallel on two or more of, such GPUs. The GPU an realize one or more application programmer interfaces (APIs) that allow programmers to invoke the functionality of the GPU. Suitable GPUs can be obtained from vendors such as NVIDIA Corporation, ATI Technologies (AMD), etc.

The system memory can be configured to store program instructions and/or data that are accessible by the processor. In various embodiments, the system memory can be realized by use of any appropriate memory technology, such as static random access memory (SRAM), synchronous dynamic RAM (SDRAM), nonvolatile/flash-type memory or any other type of memory.

The program instructions and data that realize the above-described desired functions for the application realizing the method for recognizing a gesture by use of multi-touch information in accordance with an embodiment of the present invention can be each stored within the system memory as program instructions and data storage, respectively.

In other embodiments, the program instructions and/or data can be received, transmitted or stored on different types of computer-accessible media or on similar media that are separated from the system memory or computer system. Generally, the computer-accessible medium can include storage media or memory media such as magnetic or optical media, for example, a disk or CD/DVD-ROM coupled to a computer system through an I/O interface. The program instructions and data stored through the computer-accessible medium can be transmitted by transmission media or signals such as electrical, electromagnetic, or digital signals, which can be transferred through a communication medium such as a network and/or a wireless link, which can be realized through a network interface.

In an embodiment, the I/O interface can be configured to adjust I/O traffic between the processor, the system memory, and any peripheral devices in the device, including the network interface or other peripheral interfaces, such as input/output devices. In some embodiments, the I/O interface can perform any necessary protocol, timing or other data transformations in order to convert data signals from one component (e.g., the system memory) to an appropriate format for use by another component (e.g., the processor).

In an embodiment, the I/O interface can include support for devices that are attached through various types of peripheral buses, such as a variant of the Peripheral Component Interconnect (PCI) bus standard or the Universal Serial Bus (USB) standard, in some embodiments, the function of the I/O interface can be divided into two or more individual components, such as a north bridge and a south bridge. Moreover, in some embodiments, some or all of the functions of the I/O) interface, such as interfacing the system memory, can be directly integrated into the processor.

The network interface can be configured to allow data to be exchanged between the computer system and other devices that are attached to a network, such as other computer systems, or between nodes of the computer system.

In various embodiments, the network interface can support communication through wired or wireless universal data networks, such as any suitable type of Ethernet network; through telecommunications/telephony networks, such as analog voice networks or digital fiber-optic communications networks; through storage area networks, such as Fibre Channel SANs; or through any other suitable type of network and/or protocol.

In some embodiments, the input/output devices can include one or more display terminals, keyboards, keypads, touchpads, scanning devices, voice or optical recognition devices, or any other devices suitable for inputting or searching data by one or more computer systems. It is possible that a plurality of input/output, devices are present in the computer system or distributed on various nodes of the computer system.

In an embodiment, similar input/output devices can be separated from the computer system or interact with one or more nodes of the computer system through a wired or wireless connection, for example, over the network interface.

The computer system and devices can include any combination of hard ware or software that can perform the indicated functions, including a computer, a personal computer system, a desktop computer, a laptop, notebook or netbook computer, a mainframe computer system, a handheld computer, a workstation, a network computer, a camera, a set-top box, a mobile device, a network device, an internet device, a PDA, a wireless phone, a pager, a consumer device, a video game console, a handheld video game device, an application server, a storage device, a peripheral device such as a switch, a modem or a router, or any general type of computing or electronic device.

The computer system can be also connected to other devices or alternatively operate as an independent system. Moreover, in some embodiments, the functions provided by the components can be combined in fewer components or distributed in additional components. Similarly, in some embodiments, the functions of some of the components may not be provided and/or other additional functions can be available.

It shall be appreciated by those who are skilled in the art that, while various items are stored in the memory or on the storage while being used, these items or portions thereof can be transferred between the memory and other storage devices for the purpose of memory management and data integrity. Alternatively, in other embodiments, some or all of the software components can be executed in a memory on another device and communicate with the computer system through inter-computer communication.

Some or all of the system components or data structures can be also stored on a computer-accessible medium or a portable article (e.g., as instructions or structured data) to be read by an appropriate drive, of which various examples have been described above. In some embodiments, the instructions stored on the computer-accessible medium that is separated from the computer system can be transmitted to the computer system through transmission media or signals such as electrical, electromagnetic or digital signals that are transferred through a communication medium such as a network and/or a wireless link.

Although certain embodiments of the present invention have been described hitherto, it shall be appreciated that the present invention can be variously modified and permutated by those of ordinary skill in the art to which the present invention pertains by supplementing, modifying, deleting and/or adding an element without departing from the technical ideas of the present invention, which shall be defined by the claims appended below. It shall be also appreciated that such modification and/or permutation are also included in the claimed scope of the present invention.

What is claimed is:

1. A method for recognizing a gesture by use of multi-touch information, comprising:
obtaining one or more first critical nodes, each having a greater node value than a first critical value, from points touched;
configuring a task box including all of the one or more first critical nodes;
obtaining one or more second critical nodes, each having a greater node value than a second critical value, from the one or more first critical nodes included in the task box;
obtaining a peak node having a highest node value compared to surrounding nodes from the second critical nodes; and
counting the number of the peak nodes.

2. The method of claim 1, wherein the node value is a capacitance change value.

3. The method of claim 1, wherein the task box is a rectangle.

4. The method of claim 1, wherein the step of configuring the task box comprises:
configuring horizontal lines passing the one or more first critical nodes;
configuring vertical lines passing the one or more first critical nodes;
obtaining a rectangle having a largest area from rectangles formed by the vertical lines and horizontal lines; and
configuring the rectangle having the largest area as the task box.

5. The method of claim 1, further comprising:
computing a center of gravity of the task box; and
generating a gesture corresponding to at least one selected from the group consisting of a movement direction and a movement distance of the center of gravity.

6. The method of claim 1, further comprising, after counting the number of the peak nodes:
detecting a change in the number of the peak nodes; and
generating a gesture corresponding to the change in the number of the peak nodes.

7. The method of claim 1, further comprising, after counting the number of the peak nodes;
detecting a change in a distance between the peak nodes; and
generating a gesture corresponding to the change in the distance between the peak nodes.

8. The method of claim 1, further comprising:
measuring a horizontal length and a vertical length of the task box;
detecting changes in the horizontal length and the vertical length; and
generating a gesture corresponding to the changes.

9. A device for recognizing a gesture by use of multi-touch information, comprising:
at least one processor;
a multi-touch information sensing screen; and
a memory comprising program instructions,
wherein the program instructions are executable by the at least one processor to perform the steps of:
obtaining one or more first critical nodes, each having a greater node value than a first critical value, from points touched;
configuring a task box including all of the one or more first critical nodes;
obtaining one or more second critical nodes, each having a greater node value than a second critical value, from the one or more first critical nodes included in the task box;
obtaining a peak node having a highest node value compared to surrounding nodes from the second critical nodes; and
counting the number of the peak nodes.

10. The device of claim 9, wherein the node value is a capacitance change value, and
wherein the task box is a rectangle.

11. The device of claim 9, wherein the step of configuring the task box comprises:
configuring horizontal lines passing the one or more first critical nodes;
configuring vertical lines passing the one or more first critical nodes;
obtaining a rectangle having a largest area from rectangles formed by the vertical lines and horizontal lines; and
configuring the rectangle having the largest area as the task box.

12. The device of claim 9, wherein the program instructions are configured to further execute:
computing a center of gravity of the task box; and
generating a gesture corresponding to a movement direction of the center of gravity.

13. The device of claim 9, wherein the program instructions are configured to further execute, after counting the number of the peak nodes:
detecting a change in the number of the peak nodes; and
generating a gesture corresponding to the change in the number of the peak nodes.

14. The device of claim 9, wherein the program instructions are configured to further execute:
measuring a horizontal length and a vertical length of the task box;
detecting changes in the horizontal length and the vertical length; and
generating a gesture corresponding to the changes.

15. Any terminal comprising the device of claim 9, the terminal selected from the group consisting of a portable terminal, a mobile terminal, a telematics terminal, a notebook computer, a digital multimedia broadcasting terminal, a personal digital assistant, a Wibro terminal, an Internet protocol television terminal, an audio video navigation terminal, a portable multimedia player and a GPS navigation terminal.
